(19) United States
(12) Patent Application Publication
(10) Pub. No.: US 2009/0090259 A1
(43) Pub. Date: Apr. 9, 2009

(54) Segmented Gravure Print Cylinder System

(75) Inventors: Rene Bras, New Windsor, NY (US); Rudy Bojovoski, Hopatcong, NJ (US)

Correspondence Address: LEVINE & MANDELBAUM, 222 Bloomingdale Road, Suite 203, WHITE PLAINS, NY, 10605, US

(73) Assignee: SCENTISPHERE LLC, Carmel, NY (US)

(21) Appl. No.: 12/239,977

(22) Filed: Sep. 29, 2008

Related U.S. Application Data
(60) Provisional application No. 60/976,884, filed on Oct. 2, 2007.

(51) Int. Cl. B41F 9/00

(52) U.S. Cl. 101/154

(57) ABSTRACT

A print station has print cylinder with axially spaced segments for printing different coating materials on a substrate at a single print station. The coating material is stored in adjacent wells separated by walls within a trough. The walls may be notched to receive the shaft of the print cylinder with each of the print cylinder segments disposed in one of the wells for receiving the coating material. Each of the print cylinder segments can receive the coating material from its respective well and then simultaneously in the respective well and applying it to a substrate.

### BACKGROUND OF THE INVENTION

The present invention is directed to a print cylinder system for use on a gravure printing press. More specifically, the invention enables one print station to apply multiple inks or other coatings to a substrate instead of requiring a separate print station for each type of ink or coating. For example, multiple inks of different colors can be applied to a web of paper or other sheet material at a single print station.

It is presently known in the art to employ gravure printing presses to apply colored inks and/or other coatings to a substrate made of paper or other sheet material. Gravure printing presses are manufactured with a specific number of printing stations to apply color and or coatings onto a given substrate. Each print station has its own singular gravure print cylinder to transfer one color and/or coating.

Until the present invention, a gravure print station could not print more than one color at a time. For example, a four-station press could only print four colors, i.e., apply four coatings, one at each station.

Each prior art station has a cylinder designed to receive an etched image. The cylinder picks up ink from an ink pan. The ink is metered by a single doctor blade that runs the length of the cylinder whereby the ink fills into the etched image and is scraped off the portion of the cylinder which does not include the etched image, causing the excess ink to fall back into the pan for future reapplication to the cylinder. When the substrate, e.g., paper, and cylinder come in contact, urged by an impression roller adjacent the gravure print cylinder, the ink falls or is drawn out of the etched area and is transferred onto the substrate.

A typical gravure printing press may have four stations. Each of three of the stations has a cylinder for printing one of the subtractive primary colors, namely, magenta, cyan and yellow. The fourth station prints black to control shading.

Most colors can be formed by overprinting a combination inks of the foregoing respective colors. However, specialty printing sometimes requires a special color, e.g. a particular red, which cannot be readily formed by the conventional four colors of inks found in a gravure printing press.

It is not economically feasible to retrofit gravure printing presses with additional print stations after they have been built and delivered for use when it is desired to increase the number of inks or coatings to be applied by the printing press. To increase the printing capacity of these presses by adding print stations can cost from several hundred thousand dollars to millions of dollars per station, depending upon the width of the press. This high cost deters printing companies from increasing the number of stations available for printing different colors or, otherwise, applying different coatings with their gravure printing presses

Some press configurations will not allow for additional printing stations at any cost, short of the cost of building a new printing press. In such cases, a new press is required to print more colors or coatings.

### SUMMARY OF THE INVENTION

The present invention overcomes the aforementioned limitations of prior art gravure printing presses by providing a segmented gravure print cylinder that can readily replace a conventional cylinder present on a prior art gravure printing press. The segmented print cylinder has two or more axially spaced segments mounted on a common shaft and is dimensionally compatible with the prior art press to be modified, i.e. has the same specifications as to overall shaft length, diameter, required journals and bearings, in order to allow the segmented cylinder to slide into an existing press housing that locks the shaft into position.

The segmented cylinder is actually a number of separate cylinders mounted on a common shaft for rotation in unison. Each segment has its own outer sleeve with engraved etching and a respective doctor blade to meter the ink, i.e., remove excess ink from the outer sleeve of the segment. A two cylinder design on a shaft can print 2 colors or apply two coatings, or apply one color and one coating. A 3 cylinder design on a shaft can apply any combination of three colors and/or coatings. An n cylinder design on a shaft can apply any combination of n colors and/or coatings where n is any integer.

The interchangeable segmented print cylinder also requires a re-design of the ink pan that is positioned under the print cylinder. This pan houses the ink that is picked up by the cylinder as it rotates in the pan. Ink pans for prior art gravure printing stations have an unobstructed trough that extends the width of the print cylinder. The pan is bolted to the press at each end of the printing press. This prior art design allows for only one ink color or coating material to be poured into the pan.

In accordance with the invention, a re-designed pan is split into segments with vertical walls serving as separators, each segment forming a separate well for containing an ink or other coating material. The wells are in one-to-one correspondence with the segments that form the print cylinder of the gravure printing press station.

Adding the separators to the pan allows for a different color ink or different coating, e.g., scent, to be poured into each segment or well. The top of each pan separator is notched, giving it a “U” shape so that the pan can be positioned close enough to the cylinder to allow the ink or other coating material in each well to transfer to a respective segment of the cylinder when the ink or coating in each well and the respective segment of the cylinder come into mutual contact.

The “U” shape design also allows the vertical separators to be positioned within a few thousands of an inch of the cylinder. This close proximity of the high vertical separator wall to the cylinder retains the excess ink scraped off of each segment of the print cylinder, by its respective doctor blade, within the well corresponding to the cylinder segment so that the ink or other coating material doesn't spill into an adjacent well on either side, thereby contaminating the ink or coating material in the adjacent well.

The ink pan is also constructed with separate ink inlet and outlet ports for each well which can accommodate an automatic ink pump system that manages the inflow and outflow of the ink or coating material through each well of the pan during the printing operation.

A doctor blade holder 27 is mounted on or adjacent to a longitudinal edge of the pan 15. Extending from the holder 27 in alignment with each cylinder segment 15 is a doctor blade 29 for removing excess ink or other coating material from the cylinder segments 11. The ink or other coating material removed by each doctor blade 29 falls back into a respective well 19 for reuse.

### DESCRIPTION OF THE DRAWINGS

FIG. 1 is an elevation view of a prior art print station of a gravure printing press;

FIG. 2 is a perspective view of a print station of a gravure printing press in accordance with a preferred embodiment of the invention;

FIG. 3 is an elevation view of the print station of FIG. 2;

FIG. 4 is a plan view of the print station of FIG. 2;

FIG. 5 is an end view of a component of the print station of FIG. 2.

FIG. 6 is an end view of the print station of FIG. 2.

### DESCRIPTION OF THE PREFERRED EMBODIMENT

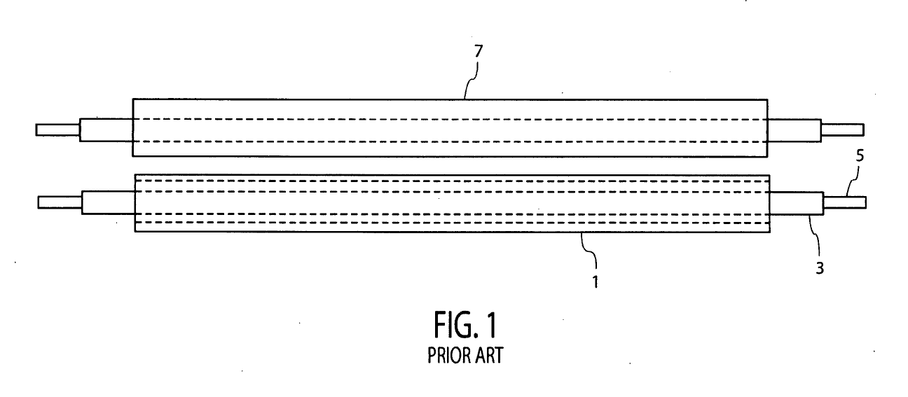

Referring now to FIG. 1 of the drawings, there is shown a print station of a prior art gravure printing press having an etched print cylinder 1 mounted on a shaft 3 having mounting pins 5 adapted to be journaled in a print station housing (not shown). An impression cylinder 7 is mounted in close parallel proximity to the print cylinder 1 for urging a substrate to be printed against the etched circumference of the print cylinder 1.

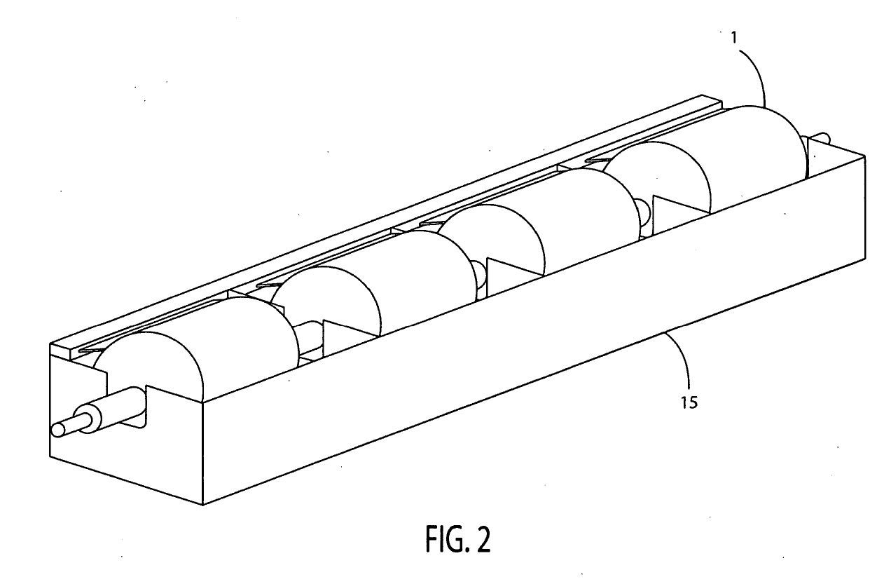

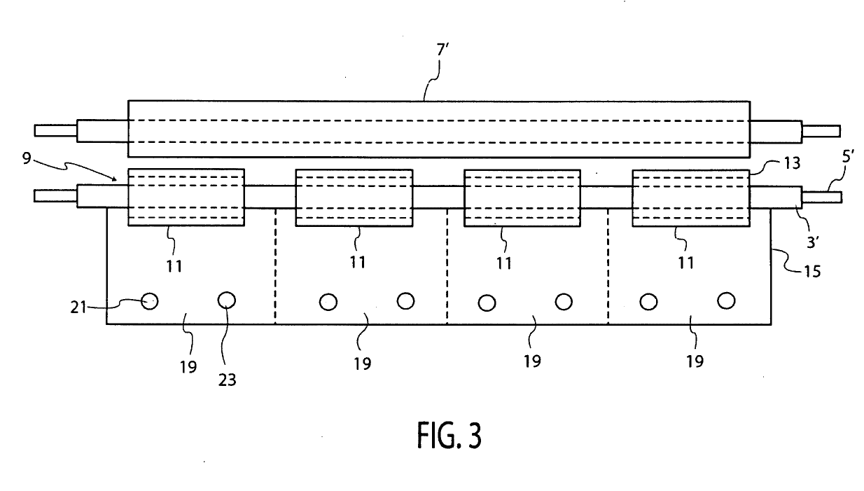

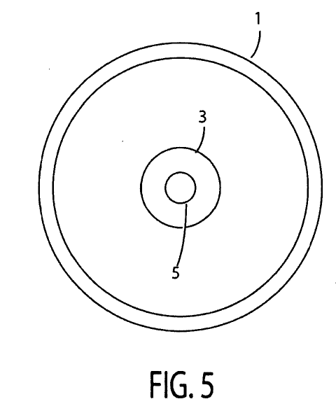

Referring now to FIGS. 2, 3, 4 and 5 of the drawings, there is shown a print station in accordance with the preferred embodiment of the invention which can replace the print station of a prior art gravure printing press as shown in FIG. 1 in order to increase the number of inks or other coatings that can be applied to a substrate at a single station. A print cylinder 9 is formed from axially adjacent etched cylindrical segments 11. The axially spaced segments 11 are mounted on a common shaft 3′ having mounting pins 5′.

Each of the segments 11 has an outer sleeve 13 with an outer diameter substantially identical to the outer diameter of the print cylinder 1 that it is intended to replace. The dimensions of the shaft 3′ and mounting pins 5″ are in conformance with the dimensional specifications of the shaft 3 and pins 5, respectively. An impression cylinder 7′ is mounted in close parallel proximity to the print cylinder 9 for urging a substrate to be printed, e.g. a web of paper, against the etched circumferences of the print cylinder segments 11.

A pan or trough 15 for containing the inks or other coating materials to be applied by the print cylinder 9 is partitioned by walls 17 to form separate wells 19, one well 19 for each respective cylinder segment 11. It is to be understood that the printing stations of the invention may employ coatings other than inks with physical characteristics other than color. For example, such coating materials may include, without limitation, scented varnishes or other carriers of scent.

Each well has an inlet port 21 and an outlet port 23 for connection to an automatic ink pump system as will be known to those skilled in the art.

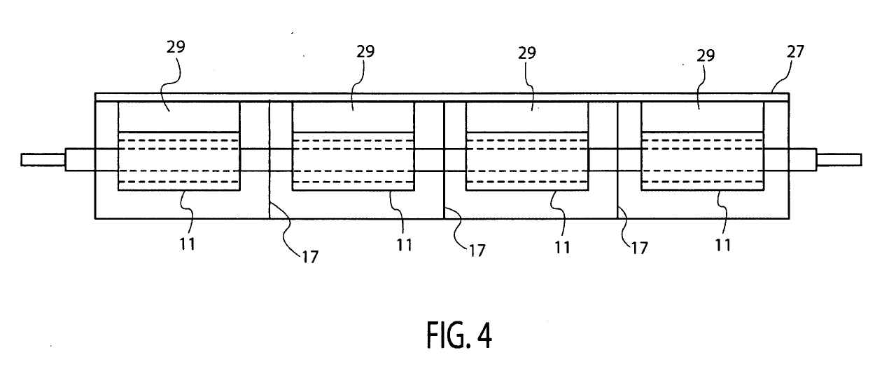

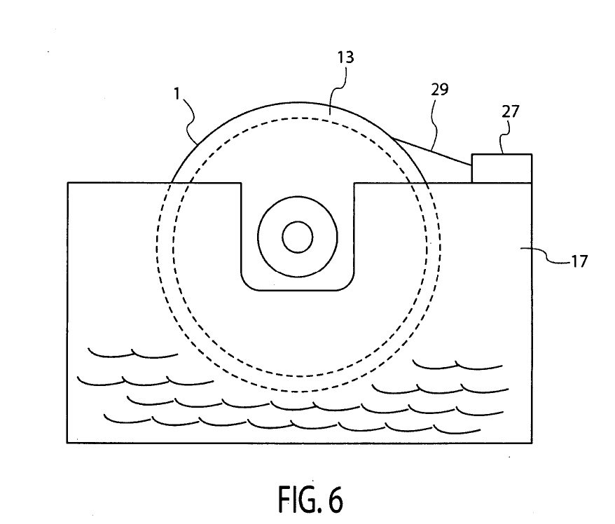

Referring to FIG. 4, it will be seen that each of the walls 17 has a U-shaped notch for receiving the shaft 3′, thereby allowing each of the axially spaced cylinder segments 11 to sit low within its respective well 19. This enables the bottom of the pan 15 to be positioned close enough to the cylinder segments 11 to allow the ink or other coating material to transfer to the cylinder segments 11 when they come in mutual contact even when the level of the ink is low. As can be seen in FIGS. 4 and 6, the portions of the shaft 3 within the spaces between adjacent cylinder segments 11 are received in the U-shaped wall notches. The spaces and the walls act as barriers to prevent unwanted flow or spray of ink or other coating material from one cylinder segment 11 to another.

It is to be appreciated that while the foregoing describes a method and apparatus for increasing the number of inks or other coating materials that can be applied with an existing gravure printing press by retrofitting the press with a cylinder system in accordance with the invention, the invention also teaches how to make a new gravure printing press wherein multiple inks or other coating materials can be applied at a single print station.

In addition to conventional pigmented color inks, the segmented gravure print cylinder design can also apply specialty coatings such as scented and flavored inks, glow in the dark inks, thermo-chromatic temperature sensitive inks, and scratch off lottery coatings. Virtually any coating that is printable by a rotogravure cylinder process can be applied by the segmented gravure cylinder system.

Moreover, although the preferred embodiment described above by way of example employs a cylinder with 4 segments, the cylinder may have anywhere from 2 segments with a maximum number of segments limited only by the desired size of the segments and the overall width of the gravure printing press.

What is claimed is:

1. A print station for a printing press used to apply a plurality of coating materials to a substrate, said print station comprising,
a trough having a plurality of wells for containing respective ones of said plurality of coating materials,
a print cylinder having an axial shaft and a plurality of axially spaced print cylinder segments in one-to-one correspondence with said plurality of wells, said print cylinder segments being mounted on said shaft for rotation about an axis of said shaft, and
an impression cylinder mounted in close parallel proximity to said print cylinder for urging said substrate to be printed against each of said print cylinder segments.

2. Apparatus according to claim 1 further comprising a plurality of walls mounted within said trough for dividing said trough into said wells, each of said cylinder segments being disposed between two adjacent ones of said walls for contacting the reservoir of coating material the well therebetween.

3. Apparatus according to claim 2 wherein each of said walls has a notch in which said shaft is received.

4. Apparatus according to claim 3 wherein each of said notches is U-shaped.

5. Apparatus according to claim 1 further comprising, a doctor blade mounted adjacent each one of said wells for engaging the outer circumference of the print cylinder segment disposed in said one well for removing excess coating material therefrom.

6. Apparatus according to claim 1 wherein each well has an inlet port and an outlet port for connection to an automatic ink pump system.

7. In a printing press used to apply coating material to a substrate, said printing press having a print station with a trough for containing said coating material, and a print cylinder for applying coating material contained in said trough to said substrate, the improvement wherein
said print cylinder comprises an axial shaft and a plurality of axially spaced print cylinder segments mounted on said shaft for rotation about an axis of said shaft, there being a gap between each pair of adjacent ones of said print cylinder segments for preventing coating material from flowing from one print cylinder segment an adjacent print cylinder segment.

8. Apparatus according to claim 7 wherein each of said print cylinder segments has an outer sleeve to which said coating material can adhere, each outer sleeve axially coextensive with the print cylinder segment on which it is mounted,
the gap between each pair of adjacent print cylinder segments acting as a barrier for preventing flow of said coating material from one outer sleeve to an adjacent outer sleeve.

9. A method of applying a plurality of coating materials to a substrate at a single station of a printing press comprising,
storing each of said coating materials in a separate well of a trough of said print station, said trough having a plurality of wells separated by walls between said wells,
rotatably mounting proximate said trough, a print cylinder having an axial shaft and a plurality of axially spaced print cylinder segments mounted on said shaft for rotation about an axis of said shaft, with each of said print cylinder segments disposed at least partially within a respective one of said wells,
simultaneously applying coating material from a plurality of said wells to the print cylinder segments disposed in said wells as said print cylinder is rotated about said axis, and
urging said substrate and said print cylinder segments into mutual contact for transferring said coating materials from said print cylinder segments to said substrate.

10. A method according to claim 9 further comprising, providing a barrier between said print cylinder segments for preventing coating material from one of said print cylinder segments from reaching another of said print cylinder segments.

11. A method according to claim 10 further comprising mounting said print cylinder proximate said trough with said walls partially disposed in respective gaps between the segments of said print cylinder.

12. A method according to claim 11 further comprising mounting said print cylinder with said shaft disposed in notches within said walls.

13. A method according to claim 9 further comprising wiping excess coating material from each of said print segment cylinders with a separate doctor blade for each print segment cylinder.

14. A method according to claim 9 further comprising engraving an outer sleeve mounted over and axially coextensive with at least one of said print segment cylinders with an etching of an image before applying a coating material thereto for printing said image on said substrate.
